(19) United States
(12) Patent Application Publication
(10) Pub. No.: US 2009/0146834 A1
(43) Pub. Date: Jun. 11, 2009

(54) Device of wireless remote control and operating method thereof

(75) Inventor: Chi-Chiang Huang, Neihu (TW)

Correspondence Address: REED SMITH LLP, 3110 FAIRVIEW PARK DRIVE, SUITE 1400, FALLS CHURCH, VA, 22042, US

(73) Assignee: Compal Communications, Inc.

(21) Appl. No.: 12/292,661

(22) Filed: Nov. 24, 2008

(30) Foreign Application Priority Data
Nov. 23, 2007 (TW) 096144398

(51) Int. Cl. G08C 19/00; G06F 3/041

(52) U.S. Cl. 340/825.72; 345/173

(57) ABSTRACT

The invention provides a wireless remote control apparatus. The wireless remote control apparatus comprises an identification module, a displaying module, and a remote control module. When the wireless remote control apparatus is pointed at an object to be remotely-controlled, the identification module is used for identifying the object and generating an identification result. The displaying module is electrically connected to the identification module, and is used for displaying a set of virtual keys corresponding to the object to be remotely-controlled according to the identification result. The remote control module is electrically connected to the displaying module. When one of the virtual keys is pressed, a remote control signal corresponding to the pressed virtual key is transmitted by the remote control module.

### BACKGROUND OF THE INVENTION

1. Field of the Invention

The invention is related to remote control, and more particularly, the invention is related to a device of wireless remote control and an operating method thereof.

2. Description of the Prior Art

Recently, various electric appliances have been created with upgraded technology. In daily life, electric appliances play very important roles, for example, a television, an air conditioner, and a DVD player.

For the user to operate these appliances conveniently, these electric appliances have a wireless remote control function. With more and more electric appliances at home, the number and kind of wireless remote controls is raising. This may become inconvenient for the user. For example, the user who wants to turn on a television cannot find the wireless remote control to use the television and as a result, the user cannot turn on the television by the television remote control. To solve the problem mentioned above, a versatile remote control exists and it is very popular.

The so called versatile remote control means the remote control can remotely control all kinds of electrical appliances. With the versatile remote control, users do not look for the corresponding wireless remote control. However, to equip the device with different functional keys for different electrical appliances, the volume of the versatile remote control cannot be reduced. Thus, the key size of the versatile remote control is very small. The user has to look for the small-sized keys corresponding to some electrical appliances while using the versatile remote control. It is not convenient.

Therefore, an aspect of the invention provides a wireless remote control apparatus and an operating method for the same.

### SUMMARY OF THE INVENTION

The invention provides a device of wireless remote control and an operating method thereof. The apparatus wirelessly remotely controls an object to be remotely-controlled by the way of automatic sensing.

One embodiment of the invention is a wireless remote control apparatus. The wireless remote control comprises an identification module, a displaying module and a remote control module. When the wireless remote is pointed at an object to be remotely-controlled, the identification module identifies the object to generate an identification result.

Compared with the prior art, the wireless remote control apparatus of the invention changes automatically with different objects to be remotely-controlled. It not only prevents from using an unmatched remote control, but also omits problems when the user remotely controls all different kinds of electrical appliances in daily life.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 illustrates a wireless remote control apparatus according to one embodiment of the present invention.

FIG. 2 illustrates 4 LED modules with different arrangements of LED.

FIG. 3 illustrates 4 LED modules with different combinations of bright and dark situations of LED.

FIG. 4 illustrates 5 LED modules with different arrangements and combinations of bright and dark situations of LED.

FIG. 5 illustrates a flow chart of an operating method for a wireless remote control apparatus according to the second embodiment of the present invention.

### DETAILED DESCRIPTION OF THE INVENTION

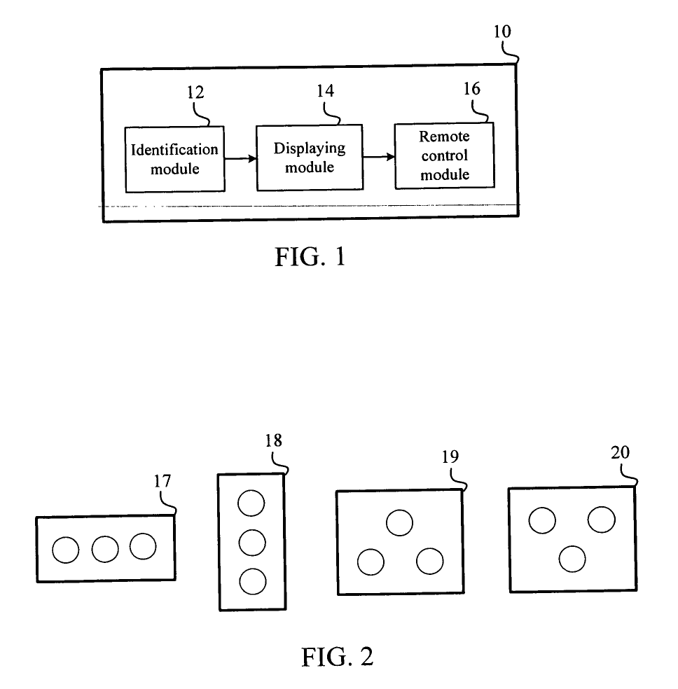

The invention provides a wireless remote control apparatus. Please refer to FIG. 1, FIG. 1 illustrates a function block diagram of the wireless remote control apparatus according to one embodiment of the invention. As shown in FIG. 1, the wireless remote control apparatus comprises an identification module 12, a displaying module 14 and a remote control module 16. The identification module 12 identifies an object to be remotely-controlled and generates an identification result when the wireless remote control apparatus 10 is pointed at the object. The displaying module 14 electrically is connected with the identification module 12 and displays a set of virtual keys corresponding to the object according to the identification result. The remote control module 16 electrically is connected with the displaying module 14 and transmits a remote control signal corresponding to the virtual keys when one of the virtual keys is pressed.

In practical application, the method for identifying the object by the identification module 12 comprises the following embodiments:

In the first embodiment, the identification module 12 comprises a CMOS image sensor. By the CMOS image sensor, the object needs not to equip with other apparatus and the identification module 12 identifies the object according to the appearance of the object.

In the second embodiment, the surface of the object comprises an identification apparatus and the identification module 12 identifies the object by the identification apparatus. For example, if the identification apparatus is an infrared transmitting module and the identification module 12 comprises an infrared receiver, the identification module 12 receives the infrared rays from the infrared transmitting module to identify the object.

The third embodiment combines the first with the second embodiment. The identification module 12 comprises a CMOS image sensor and the surface of the object comprises the identification apparatus which is an infrared light emitting diode (LED) module. The infrared LED module comprises a plurality of infrared LED and the arrangement of the infrared LED corresponds to the object. In other words, the infrared LED of different objects have different arrangements. Therefore, the identification module 12 identifies the corresponding object according to the arrangement of the infrared LED sensed by the CMOS image sensor.

The fourth embodiment combines the first with the second embodiment. If the identification module 12 comprises a CMOS image sensor and the surface of the object comprises an identification apparatus comprising N infrared LED of an infrared LED module, the N infrared LED corresponds to 2N−1 object maximum. Therefore the identification module 12 identifies the corresponding object according to the combination of bright and dark situations of the infrared LED sensed by the CMOS image sensor.

Additionally, the displaying module 14 comprises a touch panel. The touch panel displays a set of virtual keys corresponding to the object according to the identification result from the identification module 12. Thereby, the user can press at least one virtual key on the touch panel to remotely control the object. A remote control signal from the remote control module 16 is transmitted to the receiver apparatus of the object.

Take the third embodiment for example and suppose that the user wants to remotely control an air conditioner, a television, a DVD player, and a light switch. The wireless remote control comprises a CMOS image sensor. Different arrangements of the infrared LED are equipped with the air conditioner, the television, the DVD player, and the light switch. The arrangements are shown in FIG. 2.

As shown in FIG. 2, the CMOS image sensor of the wireless remote control recodes the infrared LED arrangements of the air conditioner, the television, the DVD player, and the light switch respectively.

The infrared LED module 18 of the air conditioner is arranged in a row; the infrared LED module 17 of the television is arranged in a column; the infrared LED module 19 of the DVD player is arranged in the shape of triangle Δ; and the infrared LED module 20 of light switch is arranged in the shape of reversal triangle ∇.

Therefore, the user applies the wireless remote control to point at an infrared LED module of some electric appliance for example, the infrared LED module 17 of the air condition. The CMOS image sensor can identify the pointed electric appliance as the television according to the arrangement of the infrared LED module 17. Subsequently, the touch panel of the wireless remote control displays a set of virtual keys corresponding to the air conditioner. At the same time, the user merely presses the virtual keys of the touch panel to remotely control the object without changing windows.

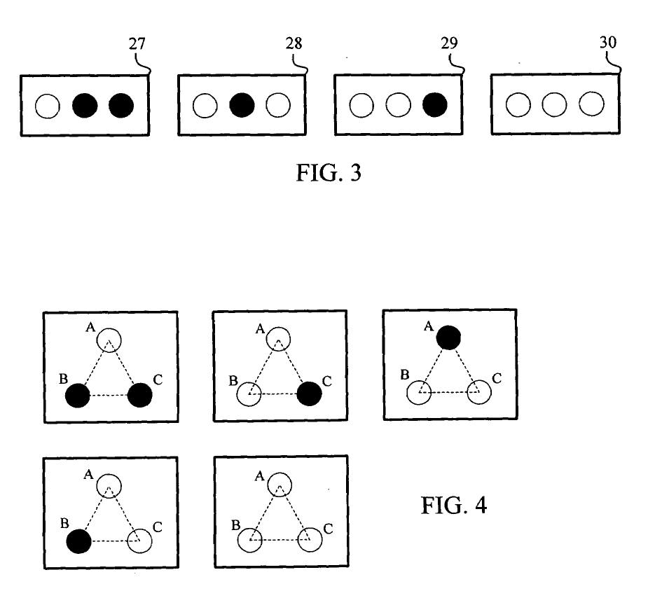

Take the fourth embodiment for example and suppose that a user remotely controls an air conditioner, a television, a DVD player, and a light switch with a wireless remote control. The wireless remote control comprises a CMOS image sensor and different combinations of bright and dark situations of infrared LED modules are equipped with the air conditioner, the television, the DVD player, and the light switch. The arrangements of the infrared LED modules are shown in FIG. 3. If N is equal to 2, there are only 2²⁻¹=2 objects which can be identified. In this case, if there are four objects to be remotely-controlled, N has to bigger than or equal to 3 (N≧3).

As shown in FIG. 3, the CMOS image sensor of the wireless remote control recodes the combinations of bright and dark situations of the infrared LED module 27 of an air conditioner, the infrared LED module 28 of a television, the infrared LED module 29 of a DVD player, and the infrared LED module 30 of a light switch. One LED of the infrared LED module 27 is light and others are dark; two LED of the infrared LED module 28 and 29 are light and others are dark; and three LED of the infrared LED module 30 are light and others are dark. To identify the infrared LED module 28 and 29, a dark infrared LED is set between the two light infrared LED of the infrared LED module 28 and there is no LED between two LED of the module 29.

The user applies the wireless remote control to point at an infrared LED module of some electric appliance for example, the infrared LED module 27 of the air conditioner. The CMOS image sensor can identify the pointed electric appliance as the television according to the arrangement of the infrared LED module 27. Subsequently, the touch panel of the wireless remote control displays a set of virtual keys corresponding to the air conditioner. At the same time, the user merely presses the virtual keys of the touch panel to remote control the object without changing windows.

Additionally, the infrared LED of the invention combines the different arrangements with different combinations of bright and dark situations. Please refer to FIG. 4. If three infrared LED arrange in the shape of equilateral triangle, the three infrared LED are the points of the equilateral triangle A, B, and C. A light infrared LED corresponds to a controlled apparatus; two light infrared LED corresponds to three controlled apparatuses; and three light infrared LED corresponds to one controlled apparatus. Therefore, the user applies the wireless remote control to point at an infrared LED module of some electric appliance. The CMOS image sensor can identify the pointed electric appliance according to the infrared LED arrangement and the combination of dark and bright situations. Subsequently, the touch panel of the wireless remote control displays a set of virtual keys corresponding to the pointed appliance. At the same time, the user merely presses the virtual keys of the touch panel to remotely control the object without changing windows.

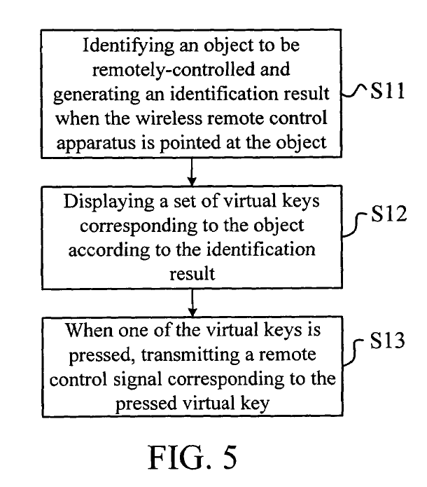

Another aspect of the present invention provides a method for operating a wireless remote control apparatus. Please refer to FIG. 5. FIG. 5 illustrates a flow chart of the method. First, when the wireless remote control apparatus is pointed at the object, step S1 is performed for identifying the object and generating an identification result. Subsequently, S2 is performed according to the identification result to display a set of virtual keys corresponding to the identification apparatus. Finally, S3 is performed. When one of the virtual keys is pressed, a remote control signal is transmitted corresponding to the pressed virtual key.

In practical application, while the step S1 is performed, there are several approaches to identify an object to be remotely-controlled as followed:

The first possible approach is as follows. Step S1 is performed by a CMOS image sensor. By the CMOS, the object needs not be equipped with other apparatus. The approach is for identifying the object according to the appearance of the object.

The second possible approach is as follows. The surface of the object comprises an identification apparatus and step S1 is performed for identifying the object by the identification apparatus. For example, if the identification apparatus is an infrared emitting module and step S1 is performed by an infrared receiver to receive the infrared rays from the infrared transmitting module to identify the object.

The third possible approach combines the first with the second possible approach. The identification apparatus is an infrared LED module. The infrared LED module comprises a plurality of infrared LED and the arrangement of the infrared LED corresponds to the object. In other words, the infrared LED of different objects have a different arrangement. Step S1 is performed by a CMOS image sensor and the CMOS image sensor identifies the corresponding object according to the arrangement of the infrared LED.

The fourth possible approach combines the first with the second possible approach. If the identification module comprises a CMOS image sensor and the surface of the object comprises an identification apparatus comprising N infrared LED of an infrared LED module, the N infrared LED corresponds to 2N−1 object maximum. In other words, different infrared LED modules correspond to different combinations of bright and dark situations. Therefore the identification module identifies the corresponding object by the CMOS image sensor sensing the combination of bright and dark situations of the infrared LED.

The fifth possible approach combines the third with the fourth approach. If the identification module comprises a CMOS image sensor and the surface of the object comprises an identification apparatus comprising N infrared LED of an infrared LED module, the N infrared LED arrange in a specific shape. Different infrared LED modules correspond to different combinations of bright and dark situations. Therefore the identification module identifies the corresponding object according to the arrangement and the combination of bright and dark situations of the infrared LED sensed by the CMOS image sensor

Additionally, step S2 is performed by a touch panel. The touch panel displays a set of virtual keys according to the identification result of step S1. Thereby, the user can press one of the virtual keys displaying on the touch panel to remotely control the object. The remote control signal mentioned in step S3 is transmitted to a receiver apparatus of the object.

Compared with the prior art, the wireless remote control apparatus and the operating method for the same according to the present invention identifies an object to remotely-controlled automatically and displays different virtual keys according to the identification result. The wireless remote control apparatus and the operating method for the same according to the present invention prevent from using an unmatched remote control. For the user, the wireless remote control apparatus according to the present invention is user-friendly and easy to operate. It is more convenient than before.

Although the present invention has been illustrated and described with reference to the preferred embodiment thereof, it should be understood that it is in no way limited to the details of such embodiment but is capable of numerous modifications within the scope of the appended claims.

What is claimed is:

1. A wireless remote control apparatus comprising:
an identification module for identifying an object to be remotely-controlled and generating an identification result when the wireless remote control apparatus is pointed at the object;
a displaying module, electrically connected with the identification module, for displaying a set of virtual keys corresponding to the object according to the identification result; and
a remote control module, electrically connected with the displaying module, wherein when one of the virtual keys is pressed, the remote control module transmits a remote control signal corresponding to the pressed virtual key.

2. The wireless remote control apparatus of claim 1, wherein the identification module comprises a CMOS image sensor.

3. The wireless remote control apparatus of claim 2, wherein the CMOS image sensor identifies the object according to the appearance of the object.

4. The wireless remote control apparatus of claim 1, wherein the displaying module comprises a touch panel.

5. The wireless remote control apparatus of claim 1, wherein a surface of the object comprises an identification apparatus and the identification module identifies the object according to the identification apparatus.

6. The wireless remote control apparatus of claim 5, wherein the identification apparatus is an infrared transmitting module, and the identification module of the wireless remote control apparatus comprises an infrared receiver.

7. The wireless remote control apparatus of claim 5, wherein the identification apparatus is an infrared light emitting diode module.

8. The wireless remote control apparatus of claim 7, wherein the infrared light emitting diode module comprises a plurality of infrared light emitting diodes, and an arrangement of the infrared light emitting diodes corresponds to the object, and wherein the identification module comprises a CMOS image sensor for identifying the object according to the arrangement of the infrared light emitting diodes.

9. The wireless remote control apparatus of claim 7, wherein the infrared light emitting diode module comprises a plurality of infrared light emitting diodes, and a combination of bright and dark situations of the infrared light emitting diodes corresponds to the object, and wherein the identification module comprises a CMOS image sensor for identifying the object by the combination of bright and dark situations.

10. A method for operating a wireless remote control apparatus, the method comprising the following steps:
(a) identifying an object to be remotely-controlled and generating an identification result when the wireless remote control apparatus is pointed at the object;
(b) displaying a set of virtual keys corresponding to the object according to the identification result; and
(c) when one of the virtual keys is pressed, transmitting a remote control signal corresponding to the pressed virtual keys.

11. The method of claim 10, wherein step (a) is performed by a CMOS image sensor.

12. The method of claim 11, wherein the CMOS image sensor identifies the object according to the appearance of the object.

13. The method of claim 10, wherein step (b) is performed by a touch panel.

14. The method of claim 10, wherein a surface of the object comprises an identification apparatus and the object is identified according to the identification apparatus in step (a).

15. The method of claim 14, wherein the identification apparatus is an infrared ray transmitting module and step (a) is performed by an infrared receiver.

16. The method of claim 14, wherein the identification apparatus is an infrared light emitting diode module.

17. The method of claim 16, wherein the infrared light emitting diode module comprises a plurality of infrared light emitting diodes, and an arrangement of the infrared light emitting diodes corresponds to the object; and step (a) is performed by a CMOS image sensor for identifying the object according to the arrangement of the infrared light emitting diodes.

18. The method of claim 16, wherein the infrared light emitting diode module comprises a plurality of infrared light emitting diodes, and a combination of bright and dark situations of the infrared light emitting diodes corresponds to the object, and step (a) is performed by a CMOS image sensor for identifying the object by the combination of bright and dark situations.
